(19) United States
(12) Patent Application Publication
(10) Pub. No.: US 2018/0087388 A1
(43) Pub. Date: Mar. 29, 2018

(54) GAS TURBINE ENGINE

(71) Applicant: Rolls-Royce plc, London (GB)

(72) Inventor: Antonios KALOCHAIRETIS, Derby (GB)

(73) Assignee: Rolls-Royce plc, London (GB)

(21) Appl. No.: 15/699,304

(22) Filed: Sep. 8, 2017

(30) Foreign Application Priority Data
Sep. 23, 2016 (GR) 20160100483

(51) Int. Cl. F01D 5/30

(52) U.S. Cl. CPC F01D 5/303; F05D 2260/30; F05D 2240/20; F01D 5/3046

(57) ABSTRACT

A gas turbine engine comprises a disc having a disc slot and a circumferential groove extending from the slot. A blade having a blade root positioned in the disc slot. The blade root has an integrally formed circumferential protrusion that is received in the circumferential groove of the disc.

### CROSS-REFERENCE TO RELATED APPLICATIONS

This specification is based upon and claims the benefit of priority from Greek Patent Application Number 2016100483 filed on 23 Sep. 2016, the entire contents of which are incorporated herein by reference.

### FIELD OF DESCRIPTION

The present disclosure concerns a fan blade and/or a gas turbine engine.

### DESCRIPTION OF RELATED ART

Gas turbine engines are typically employed to power aircraft. Typically a gas turbine engine will comprise an axial fan driven by an engine core. The engine core is generally made up of one or more turbines which drive respective compressors via coaxial shafts. The fan is usually driven off an additional lower pressure turbine in the engine core.

The fan includes a plurality of fan blades arranged around a disc. The blades may be integrally formed with the disc or the blades and disc may be formed separately, and a blade root of the blades may be received in a complimentary slot in the disc. The blade root and slot of the disc may have any suitable shape, but are often dovetail shaped.

Engagement of the slot and the root of the blade retains the fan blade in position with respect to the disc in a radial and circumferential direction. However, to retain the fan blade in an axial direction an additional retention arrangement is needed. An example of such a retention arrangement, that can also transfer loads to the disc in extreme events such as bird strike or foreign object impact, is explained in detail in U.S. Pat. No. 544,336 which is incorporated herein by reference, and will now be briefly described with reference to FIGS. 1A and 1B. The fan blade root 126 includes a groove 128 which receives a U-shaped key member 130. The key member is connected to the blade root using a strap 132 that is connected, e.g. using two pins, to the blade root. A disc for use with the blade of FIGS. 1A and 1B includes an axially extending slot for receiving the blade root. A groove is also provided in the disc and circumferentially extends from the slot.

The groove is positioned so as to receive the key member 130 when the blade root is received in the slot of the disc.

A sprung member 140 and a slider 142 are provided to fix the blade with respect to the disc. To assemble a blade to the disc, the key member 130 is connected to the blade root. The blade root and key member are then slide into the slot of the disc, so that the key member is axially aligned with the respective grooves of the disc. The spring member 140 is provided in the slot of the disc, and the slider 142 is moved into the slot so as to cause the spring member to bias the key member into the grooves of the disc.

### SUMMARY

According to an aspect there is provided a gas turbine engine comprising a disc having a disc slot (e.g. a plurality of disc slots) and a circumferential groove extending from the slot. A blade (e.g. a plurality of blades) having a blade root positioned in the disc slot. The blade root has an integrally formed circumferential protrusion that is received in the circumferential groove of the disc.

The circumferential groove and circumferential protrusion may be considered to be an axial retention arrangement. The circumferential protrusion may be considered to be an integral axial retention member.

The blade root may comprise two circumferential protrusions and the disc may include two grooves extending from each slot. One protrusion and groove may be on a suction side of the blade and the other protrusion and groove may be on the pressure side of the blade. The two circumferential protrusions may be located in the same chordwise position and the two circumferential grooves may be located in the same chordwise position.

The protrusion may protrude from a flank of the blade root.

The protrusion and groove may be positioned towards one chordal end of the blade.

The protrusion and groove may be positioned towards the leading edge of the blade.

The protrusions may extend in a chordwise direction by approximately 5 to 10% of the length of the blade root.

The protrusion may have a substantially rectangular cross section with rounded corners.

The blade may be a fan blade and the disc may be a fan disc.

According to an aspect there is provided a blade comprising a blade root and a circumferentially extending projection formed integrally with the blade root and extending therefrom.

The fan blade may be a fan blade of the gas turbine engine according to the previous aspect.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1A is a perspective exploded view of a fan blade root with a key member;

FIG. 1B is perspective view of a fan blade root and key member of FIG. 1A with a spring member and slider assembly;

FIG. 2 is a sectional side view of a gas turbine engine;

FIG. 3 is a perspective view of a slot in a fan disc; and

FIG. 4 is a perspective view of the root of a fan blade.

### DETAILED DESCRIPTION OF THE DISCLOSURE

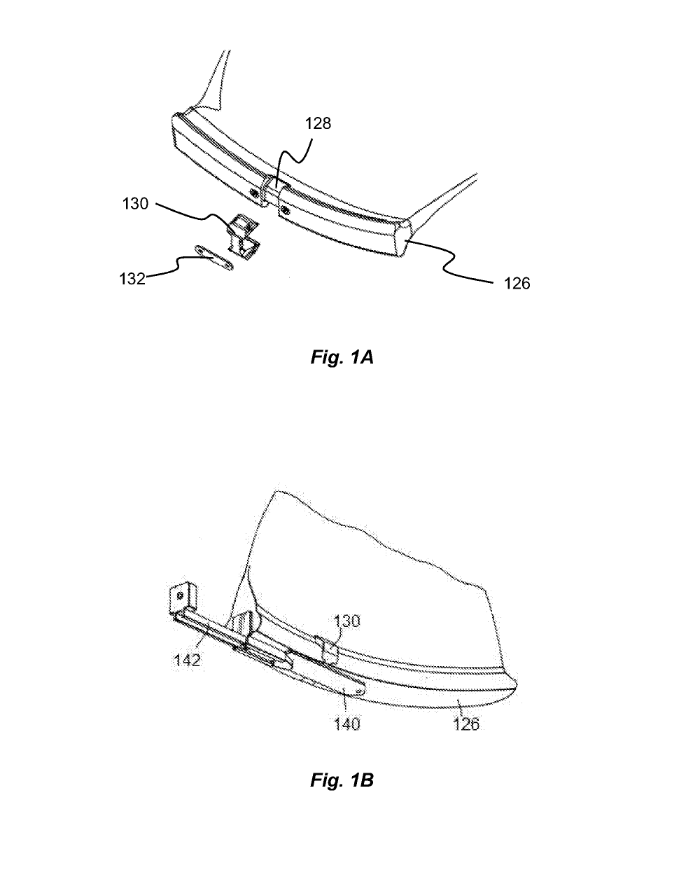

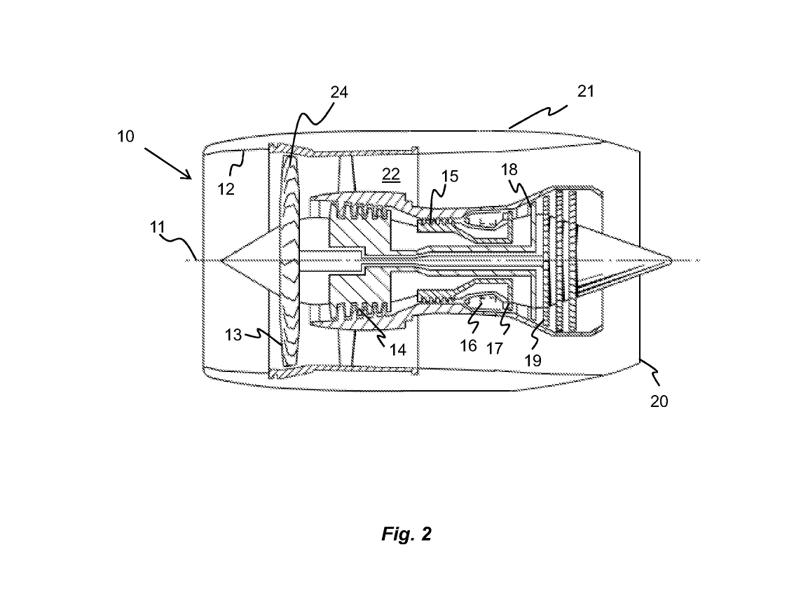

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The fan 13 includes a plurality of fan blades 24 extending from a disc, which may also be considered to be a hub.

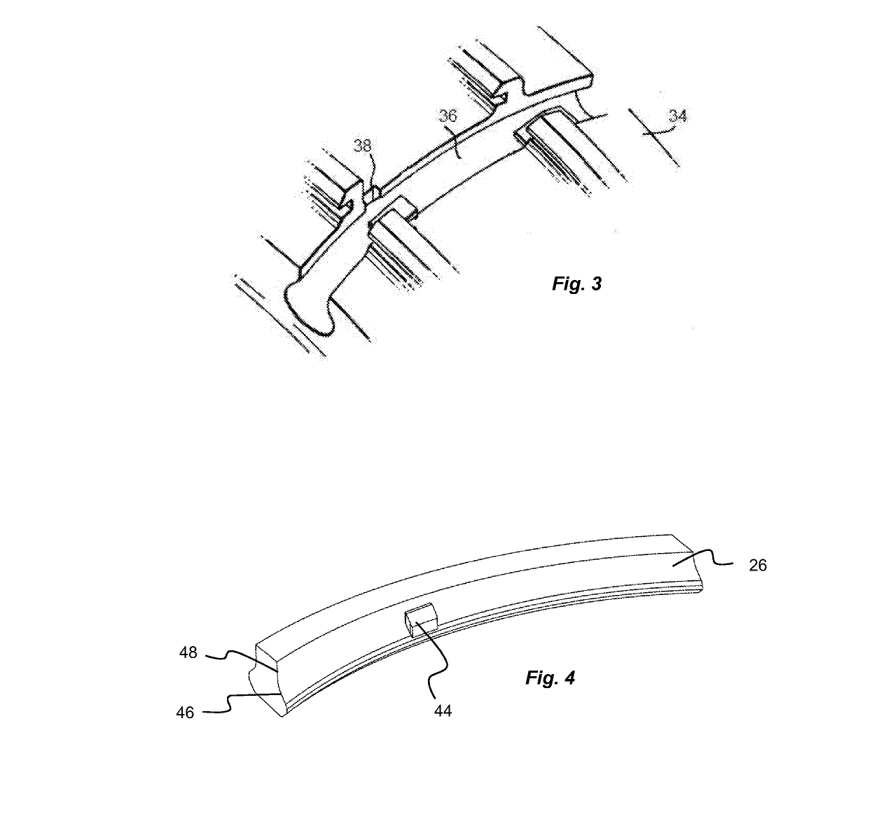

Referring to FIG. 3, the fan disc 34 includes an axially (or chordwise) extending slot 36. In the present example, the slot is dovetail shaped, but may be any suitable shape. The disc also includes a groove 38. The groove 38 extends circumferentially from and away from the slot 36 of the disc. In the present example the groove is provided proximal to a forward-most position of the fan disc. The groove is substantially rectangular in cross section. Referring to FIG. 4, the fan blades include a fan blade root 26 that is dove tailed in shape. The shape and size of the fan blade root is complimentary to the shape and size of the slot 36 of the disc 34. An integral retention feature is provided on the blade root. The retention feature is a projection 44 that is formed integrally with the fan blade root. The retention feature is provided on a flank 46 of the fan blade root and extends to a section 48 of the blade root that extends in a substantially spanwise (and chordwise) direction.

The projection 44 is substantially rectangular in cross section and includes rounded edges. The transition between the remainder of the root and the projection may define a curved surface. In this way, there are no sharp corners between the projection and the remainder of the fan blade root. In the present example, the projection extends approximately 5 to 10% of the chordwise length of the fan blade root. However, the projection may extend any suitable length. In FIG. 4, only one projection is shown (i.e. the projection on the pressure side of the blade), but a further projection is provided on the opposite side of the fan blade (i.e. on the suction side of the blade). The projection on the opposite side of the fan blade is provided at the same chordwise position as the projection shown in FIG. 4. Both projections also have the same shape and size. Referring to FIGS. 3 and 4, the disc 34 may be formed roughly to shape and size, e.g. by forging, and then disc may be machined to the desired dimensions and to include the desired features. During this machining process the slots 36 and the grooves 38 can be formed in the disc. The disc can then be post-processed, for example treated for compressive strength using a technique such as deep cold rolling.

The blade root 26 may be machined from solid, and the projection 44 may be defined during this machining process. The blade root and projection may then be post-processed to improve compressive strength. For example, the blade root and projection may be deep cold rolled.

In use, the fan blade is assembled in a similar manner to that described in relation to the blade is disc of U.S. Pat. No. 544,336 which is incorporated herein by reference, but without the need to assemble a retention arrangement to the fan blade root. The fan blade root 26 is received in the fan disc slot 36. The projections 44 are such that they do not interfere with the sides of the fan disc slot whilst the fan blade root is slid into place in the slot of the disc. A spring member and slider, similar to that shown in U.S. Pat. No. 544,336 is then used to bias the fan blade root radially outwardly, such that the projections 44 are received in the respective grooves 38 of the fan disc 34.

The described axial retention arrangement with a retention member formed integrally with the fan blade root can provide the following advantages:
The assembly of the gas turbine engine can be simplified because there are fewer parts to assemble, and the risk of the wrong shear key being fitted a fan blade can be mitigated. Fitting the wrong shear key could result in reduced performance in an impact scenario, e.g. bird strike.
Reduce the number of machining processes required to manufacture the fan blade.
Simplify the manufacturing process by no longer needing to machine a groove in the blade root to receive a key member.
Reduce residual stresses in the component.
Increase the capability of the fan to withstand bird strike and foreign object impact.
Reduce costs for example by reducing the number of components of the blade and disc arrangement, reducing the amount of material waste when the blade is machined, and allowing lower cost compressive strength processes (such as deep cold rolling) to be used rather than more conventional processes such as shot peening.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

For example, this axial retention arrangement may be used between a disc and blade of a compressor or a turbine.

The geometry, size and position of the projection on the blade root (and groove of the disc) may be selected to be appropriate for a given application.

The described blade root is dove tailed in shape, but it may be any other suitable shape, for example fir tree shaped.

We claim:

1. A gas turbine engine comprising:
a disc having a plurality of disc slots and a circumferential groove extending from each slot; and
a plurality of blades each having a blade root positioned in one of the plurality of disc slots, each blade root having an integrally formed circumferential protrusion protruding from a flank of the blade root that is received in the respective circumferential groove of the disc.

2. The gas turbine engine according to claim 1, wherein the blade root comprises two circumferential protrusions and the disc includes two grooves extending from each slot, wherein one protrusion and groove is on a suction side of the respective blade and the other protrusion and groove is on the pressure side of the respective blade, and wherein the two circumferential protrusions are located in the same chordwise position and the two circumferential grooves are located in the same chordwise position.

3. The gas turbine engine according to claim 1, wherein the protrusion and groove are positioned towards one chordal end of the blade.

4. The gas turbine engine according to claim 3, wherein the protrusion and groove are positioned towards the leading edge of the blade.

5. The gas turbine engine according to claim 1, wherein the protrusions extend in a chordwise direction by approximately 5 to 10% of the length of the blade root.

6. The gas turbine engine according to claim 1, wherein the protrusion has a substantially rectangular cross section with rounded corners.

7. The gas turbine engine according to claim 1, wherein the blade is a fan blade and the disc is a fan disc.

8. A blade comprising:
a blade root; and
a circumferentially extending projection formed integrally with the blade root and extending from a flank of the blade root.

9. A gas turbine engine comprising:
a fan disc having a plurality of disc slots and two circumferential grooves extending from each slot, one groove being provided on a suction side and one groove being provided on a pressure side; and
a plurality of fan blades each having a blade root positioned in one of the plurality of disc slots, each blade root having a two integrally formed circumferential protrusions protruding from a flank of the blade root, one in a direction towards a pressure side of the fan blade and one in a direction towards the suction side of the fan blade,
wherein protrusion on the pressure side is received in the circumferential groove on the pressure side and the protrusion on the suction side is received in the circumferential groove on the suction side.

10. The gas turbine engine according to claim 9, wherein the two protrusions are protruding from the blade root are aligned in a chordal direction.

11. The gas turbine engine according to claim 9, wherein the protrusion and groove are positioned towards the leading edge of the blade.
